(19) United States
(12) Patent Application Publication
(10) Pub. No.: US 2020/0120438 A1
(43) Pub. Date: Apr. 16, 2020

(54) RECURSIVELY DEFINED AUDIO METADATA

(71) Applicant: QUALCOMM Incorporated, San Diego, CA (US)

(72) Inventors: Moo Young Kim, San Diego, CA (US); Shankar Thagadur Shivappa, San Diego, CA (US); Dipanjan Sen, Dublin, CA (US); Ferdinando Olivieri, San Diego, CA (US)

(21) Appl. No.: 16/584,599

(22) Filed: Sep. 26, 2019

Related U.S. Application Data
(60) Provisional application No. 62/743,930, filed on Oct. 10, 2018.

(51) Int. Cl. H04S 7/00; H04R 5/02; H04S 3/00

(52) U.S. Cl. CPC H04S 7/303; H04R 5/02; H04S 2400/01; H04S 2420/11; H04S 2400/11; H04S 3/008

(57) ABSTRACT

In general, techniques are described for recursively defined audio metadata. A device comprising one or more memories and one or more processors may be configured to perform various aspects of the techniques. The one or more memories may store at least a portion of the bitstream. The one or more processors may obtain, from the bitstream, recursively defined audio metadata, and obtain, from the bitstream, a representation of the audio data. The one or more processors may process, based on the recursively defined audio metadata, the representation of the audio data to obtain one or more speaker feeds, and output the one or more speaker feeds to one or more speakers.

This application claims the benefit of U.S. Provisional Application Ser. No. 62/743,930, entitled “RECURSIVELY DEFINED AUDIO METADATA,” filed Oct. 10, 2018, the entire contents of which are hereby incorporated by reference as if set forth in its entirety.

### TECHNICAL FIELD

This disclosure relates to audio data and, more specifically, defining audio metadata in bitstreams.

### BACKGROUND

An ambisonic signal (often represented by a plurality of spherical harmonic coefficients (SHC) or other hierarchical elements, where coefficients associated with spherical basis function having an order greater than one may be referred to as “Higher Order Ambisonic coefficient” or “HOA coefficients”) is a three-dimensional (3D) representation of a soundfield. The ambisonic representation may represent this soundfield in a manner that is independent of the local speaker geometry used to playback a multi-channel audio signal rendered from this ambisonic signal. The ambisonic signal may also facilitate backwards compatibility as the ambisonic signal may be rendered to well-known and highly adopted multi-channel formats, such as a 5.1 audio channel format or a 7.1 audio channel format. The ambisonic representation may therefore enable a better representation of a soundfield that also accommodates backward compatibility.

### SUMMARY

In general, techniques are described for recursively defined audio metadata in a bitstream. Rather than specify audio metadata in a static or fixed manner, which may limit precision of the audio metadata to some fixed or static range, various aspects of the techniques may enable an audio encoding device to specify the audio metadata recursively to provide a dynamically adjustable range, while also potentially reducing error. As such, the techniques may enable audio encoders and audio decoders themselves to better encode audio data, as a higher range may permit better localization of the audio data, while also reducing the injection of error that may result in audio artifacts during playback.

In one example, various aspects of the techniques are directed to a device configured to process a bitstream representative of audio data that describes a soundfield, the device comprising: one or more memories configured to store at least a portion of the bitstream; one or more processors configured to: obtain, from the bitstream, recursively defined audio metadata; obtain, from the bitstream, a representation of the audio data; process, based on the recursively defined audio metadata, the representation of the audio data to obtain one or more speaker feeds; and output the one or more speaker feeds to one or more speakers.

In another example, various aspects of the techniques are directed to a method of processing a bitstream representative of audio data that describes a soundfield, the method comprising: obtaining, from the bitstream, recursively defined audio metadata; obtaining, from the bitstream, a representation of the audio data; processing, based on the recursively defined audio metadata, the representation of the audio data to obtain one or more speaker feeds; and outputting the one or more speaker feeds to one or more speakers.

In another example, various aspects of the techniques are directed to a device configured to process a bitstream representative of audio data that describes a soundfield, the device comprising: means for obtaining, from the bitstream, recursively defined audio metadata; means for obtaining, from the bitstream, a representation of the audio data; means for processing, based on the recursively defined audio metadata, the representation of the audio data to obtain one or more speaker feeds; and means for outputting the one or more speaker feeds to one or more speakers.

In another example, various aspects of the techniques are directed to a non-transitory computer-readable storage medium having stored thereon instructions that, when executed, cause one or more processors to: obtain, from a bitstream representative of audio data that describes a soundfield, recursively defined audio metadata; obtaining, from the bitstream, a representation of the audio data; processing, based on the recursively defined audio metadata, the representation of the audio data to obtain one or more speaker feeds; and outputting the one or more speaker feeds to one or more speakers.

In another example, various aspects of the techniques are directed to a device configured to obtain a bitstream representative of audio data describing a soundfield, the device comprising: one or more memories configured to store the audio data; one or more processors configured to: recursively specify, in the bitstream, audio metadata associated with the audio data, the audio metadata enabling, at least in part, processing of the audio data to obtain one or more speaker feeds; specify, in the bitstream, a representation of the audio data; and output the bitstream.

In another example, various aspects of the techniques are directed to a method of obtaining a bitstream representative of audio data describing a soundfield, the device comprising: recursively specifying, in the bitstream, audio metadata associated with the audio data, the audio metadata enabling, at least in part, processing of the audio data to obtain one or more speaker feeds; specifying, in the bitstream, a representation of the audio data; and outputting the bitstream.

In another example, various aspects of the techniques are directed to a device configured to obtain a bitstream representative of audio data describing a soundfield, the device comprising: means for recursively specifying, in the bitstream, audio metadata associated with the audio data, the audio metadata enabling, at least in part, processing of the audio data to obtain one or more speaker feeds; means for specifying, in the bitstream, a representation of the audio data; and means for outputting the bitstream.

In another example, various aspects of the techniques are directed to a non-transitory computer-readable storage medium having stored thereon instructions that, when executed, cause one or more processors to: specify, in a bitstream representative of a compressed version of audio data describing a soundfield, audio metadata associated with the audio data, the audio metadata enabling, at least in part, processing of the audio data to obtain one or more speaker feeds; specify, in the bitstream, a representation of the audio data; and output the bitstream.

The details of one or more aspects of the techniques are set forth in the accompanying drawings and the description below. Other features, objects, and advantages of these techniques will be apparent from the description and drawings, and from the claims.

### BRIEF DESCRIPTION OF DRAWINGS

FIG. 1 is a diagram illustrating a system that may perform various aspects of the techniques described in this disclosure.

FIGS. 2A-2D are diagrams illustrating different examples of the system shown in the example of FIG. 1.

FIG. 3 is a block diagram illustrating another example of the system shown in the example of FIG. 1.

FIG. 4 is a diagram illustrating how statically defined audio metadata may impact encoding and decoding of audio data.

FIG. 5 is a diagram illustrating how recursively defined audio metadata may promote potentially better representations of the audio data during encoding and decoding according to various aspects of the techniques described in this disclosure.

FIG. 6 is a flowchart illustrating example operation of the spatial audio encoding device shown in the example of FIG. 1 in performing various aspects of the techniques described in this disclosure.

FIG. 7 is a flowchart illustrating example operation of the audio decoding device shown in the example of FIG. 1 in performing various aspects of the techniques described in this disclosure.

### DETAILED DESCRIPTION

There are a number of different ways to represent a soundfield. Example formats include channel-based audio formats, object-based audio formats, and scene-based audio formats. Channel-based audio formats refer to the 5.1 surround sound format, 7.1 surround sound formats, 22.2 surround sound formats, or any other channel-based format that localizes audio channels to particular locations around the listener in order to recreate a soundfield.

Object-based audio formats may refer to formats in which audio objects, often encoded using pulse-code modulation (PCM) and referred to as PCM audio objects, are specified in order to represent the soundfield. Such audio objects may include metadata identifying a location of the audio object relative to a listener or other point of reference in the soundfield, such that the audio object may be rendered to one or more speaker channels for playback in an effort to recreate the soundfield. The techniques described in this disclosure may apply to any of the foregoing formats, including scene-based audio formats, channel-based audio formats, object-based audio formats, or any combination thereof.

Scene-based audio formats may include a hierarchical set of elements that define the soundfield in three dimensions. One example of a hierarchical set of elements is a set of spherical harmonic coefficients (SHC). The following expression demonstrates a description or representation of a soundfield using SHC:

$${p}_{i} ( t , {r}_{r} , {θ}_{r} , {ϕ}_{r} ) = {\sum }_{ω = 0}^{∞} [ 4 π {\sum }_{n = 0}^{∞} {j}_{n} ( {kr}_{r} ) {\sum }_{n = 0}^{∞} {j}_{n} ( {kr}_{r} ) {\sum }_{m = - n}^{n} {A}_{n}^{m} ( k ) {Y}_{n}^{m} ( {θ}_{r} , {ϕ}_{r} ) ] {e}^{j ω t} ,$$

The expression shows that the pressure pᵢ at any point {rᵣ, θᵣ, φᵣ} of the soundfield, at time t, can be represented uniquely by the SHC, Aₙ^{m}(k). Here,

$$k = \frac{ω}{c} ,$$

c is the speed of sound (˜343 m/s), {rᵣ, θᵣ, φᵣ} is a point of reference (or observation point), jₙ(⋅) is the spherical Bessel function of order n, and Yₙ^{m}(θᵣ,φᵣ) are the spherical harmonic basis functions (which may also be referred to as a spherical basis function) of order n and suborder m. It can be recognized that the term in square brackets is a frequency-domain representation of the signal (i.e., S(ω,rᵣ,θᵣ,φᵣ)) which can be approximated by various time-frequency transformations, such as the discrete Fourier transform (DFT), the discrete cosine transform (DCT), or a wavelet transform. Other examples of hierarchical sets include sets of wavelet transform coefficients and other sets of coefficients of multiresolution basis functions.

The SHC Aₙ^{m}(k) can either be physically acquired (e.g., recorded) by various microphone array configurations or, alternatively, they can be derived from channel-based or object-based descriptions of the soundfield. The SHC (which also may be referred to as ambisonic coefficients) represent scene-based audio, where the SHC may be input to an audio encoder to obtain encoded SHC that may promote more efficient transmission or storage. For example, a fourth-order representation involving (1+4)² (25, and hence fourth order) coefficients may be used.

As noted above, the SHC may be derived from a microphone recording using a microphone array. Various examples of how SHC may be physically acquired from microphone arrays are described in Poletti, M., “Three-Dimensional Surround Sound Systems Based on Spherical Harmonics,” J. Audio Eng. Soc., Vol. 53, No. 11, 2005 November, pp. 1004-1025.

The following equation may illustrate how the SHCs may be derived from an object-based description. The coefficients Aₙ^{m}(k) for the soundfield corresponding to an individual audio object may be expressed as:

Aₙ^{m}(k)=g(ω)(−4πik)hₙ⁽²⁾(krₛ)Yₙ^{m}*(θₛ,φₛ),

where i is \sqrt{−1}, hₙ⁽²⁾(⋅) is the spherical Hankel function (of the second kind) of order n, and {rₛ, θₛ, φₛ} is the location of the object. Knowing the object source energy g(ω) as a function of frequency (e.g., using time-frequency analysis techniques, such as performing a fast Fourier transform on the pulse code modulated—PCM—stream) may enable conversion of each PCM object and the corresponding location into the SHC Aₙ^{m}(k). Further, it can be shown (since the above is a linear and orthogonal decomposition) that the Aₙ^{m}(k) coefficients for each object are additive. In this manner, a number of PCM objects can be represented by the Aₙ^{m}(k) coefficients (e.g., as a sum of the coefficient vectors for the individual objects). The coefficients may contain information about the soundfield (the pressure as a function of 3D coordinates), and the above represents the transformation from individual objects to a representation of the overall soundfield, in the vicinity of the observation point {rᵣ, θᵣ, φᵣ}.

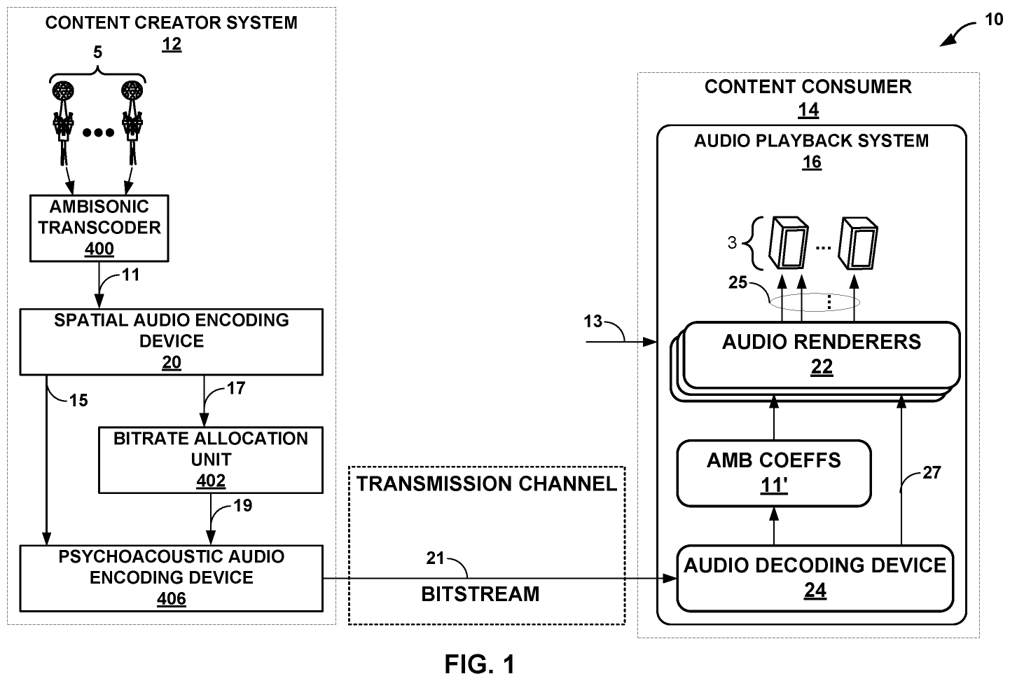

FIG. 1 is a diagram illustrating a system 10 that may perform various aspects of the techniques described in this disclosure. As shown in the example of FIG. 1, the system 10 includes a content creator system 12 and a content consumer 14. While described in the context of the content creator system 12 and the content consumer 14, the techniques may be implemented in any context in which SHCs (which may also be referred to as ambisonic coefficients or, when certain coefficients are associated with spherical basis functions having an order greater than one, higher order ambisonic—HOA—coefficients) or any other hierarchical representation of a soundfield are encoded to form a bitstream representative of the audio data.

Moreover, the content creator system 12 may represent a system comprising one or more of any form of computing devices capable of implementing the techniques described in this disclosure, including a handset (or cellular phone, including a so-called “smart phone”), a tablet computer, a laptop computer, a desktop computer, or dedicated hardware to provide a few examples or. Likewise, the content consumer 14 may represent any form of computing device capable of implementing the techniques described in this disclosure, including a handset (or cellular phone, including a so-called “smart phone”), a tablet computer, a television, a set-top box, a laptop computer, a gaming system or console, or a desktop computer to provide a few examples.

The content creator network 12 may represent any entity that may generate multi-channel audio content and possibly video content for consumption by content consumers, such as the content consumer 14. The content creator system 12 may capture live audio data at events, such as sporting events, while also inserting various other types of additional audio data, such as commentary audio data, commercial audio data, intro or exit audio data and the like, into the live audio content.

The content consumer 14 represents an individual that owns or has access to an audio playback system, which may refer to any form of audio playback system capable of rendering higher order ambisonic audio data (which includes higher order audio coefficients that, again, may also be referred to as spherical harmonic coefficients) to speaker feeds for play back as so-called “multi-channel audio content.” The ambisonic audio data may be defined in the spherical harmonic domain and rendered or otherwise transformed from the spherical harmonic domain to a spatial domain, resulting in the multi-channel audio content in the form of one or more speaker feeds. In the example of FIG. 1, the content consumer 14 includes an audio playback system 16.

The content creator system 12 includes microphones 5 that record or otherwise obtain live recordings in various formats (including directly as ambisonic coefficients and audio objects). When the microphone array 5 (which may also be referred to as “microphones 5”) obtains live audio directly as the ambisonic coefficients, the microphones 5 may include an ambisonic transcoder, such as an ambisonic transcoder 400 shown in the example of FIG. 1.

In other words, although shown as separate from the microphones 5, a separate instance of the ambisonic transcoder 400 may be included within each of the microphones 5 so as to naturally transcode the captured feeds into the ambisonic coefficients 11. However, when not included within the microphones 5, the ambisonic transcoder 400 may transcode the live feeds output from the microphones 5 into the ambisonic coefficients 11. In this respect, the ambisonic transcoder 400 may represent a unit configured to transcode microphone feeds and/or audio objects into the ambisonic coefficients 11. The content creator system 12 therefore includes the ambisonic transcoder 400 as integrated with the microphones 5, as an ambisonic transcoder separate from the microphones 5 or some combination thereof.

For instance, to generate the different representations of the soundfield using ambisonic coefficients (which again is one example of the audio streams), the ambisonic transcoder 400 may use a coding scheme for ambisonic representations of a soundfield, referred to as Mixed Order Ambisonics (MOA) as discussed in more detail in U.S. application Ser. No. 15/672,058, entitled “MIXED-ORDER AMBISONICS (MOA) AUDIO DATA FO COMPUTER-MEDIATED REALITY SYSTEMS,” filed Aug. 8, 2017, and published as U.S. patent publication no. 20190007781 on Jan. 3, 2019.

To generate a particular MOA representation of the soundfield, the ambisonic transcoder 400 may generate a partial subset of the full set of ambisonic coefficients. For instance, each MOA representation generated by the ambisonic transcoder 400 may provide precision with respect to some areas of the soundfield, but less precision in other areas. In one example, an MOA representation of the soundfield may include eight (8) uncompressed ambisonic coefficients, while the third order ambisonic representation of the same soundfield may include sixteen (16) uncompressed ambisonic coefficients. As such, each MOA representation of the soundfield that is generated as a partial subset of the ambisonic coefficients may be less storage-intensive and less bandwidth intensive (if and when transmitted as part of the bitstream 21 over the illustrated transmission channel) than the corresponding third order ambisonic representation of the same soundfield generated from the ambisonic coefficients.

Although MOA representations represent one type of ambisonic representation, the techniques of this disclosure may also be performed with respect to first-order ambisonic (FOA) representations in which all of the ambisonic coefficients associated with a first order spherical basis function and a zero order spherical basis function are used to represent the soundfield. In other words, rather than represent the soundfield using a partial, non-zero subset of the ambisonic coefficients, the ambisonic transcoder 400 may represent the soundfield using all of the ambisonic coefficients for a given order N, resulting in a total of ambisonic coefficients equaling (N+1)².

In this respect, the ambisonic audio data (which is another way to refer to the ambisonic coefficients in either MOA representations or full order representations, such as the first-order representation noted above) may include ambisonic coefficients associated with spherical basis functions having an order of one or less (which may be referred to as “1^{st} order ambisonic audio data”), ambisonic coefficients associated with spherical basis functions having a mixed order and suborder (which may be referred to as the “MOA representation” discussed above), or ambisonic coefficients associated with spherical basis functions having an order greater than one (which is referred to above as the “full order representation”).

In any event, the content creator system 12 may also include a spatial audio encoding device 20, a bitrate allocation unit 402, and a psychoacoustic audio encoding device 406. The spatial audio encoding device 20 may represent a device capable of performing the compression techniques described in this disclosure with respect to the ambisonic coefficients 11 to obtain intermediately formatted audio data 15 (which may also be referred to as “mezzanine formatted audio data 15” when the content creator system 12 represents a broadcast network as described in more detail below).

Intermediately formatted audio data 15 may represent audio data that is compressed using the spatial audio compression techniques but that has not yet undergone psychoacoustic audio encoding (such as a unified speech and audio coder denoted as “USAC” set forth by the Moving Picture Experts Group (MPEG), the MPEG-H 3D audio coding standard, the MPEG-I Immersive Audio standard, or proprietary standards, such as AptX™ (including various versions of AptX such as enhanced AptX—E-AptX, AptX live, AptX stereo, and AptX high definition—AptX-HD), advanced audio coding (AAC), Audio Codec 3 (AC-3), Apple Lossless Audio Codec (ALAC), MPEG-4 Audio Lossless Streaming (ALS), enhanced AC-3, Free Lossless Audio Codec (FLAC), Monkey's Audio, MPEG-1 Audio Layer II (MP2), MPEG-1 Audio Layer III (MP3), Opus, and Windows Media Audio (WMA)). Although described in more detail below, the spatial audio encoding device 20 may be configured to perform this intermediate compression with respect to the ambisonic coefficients 11 by performing, at least in part, a decomposition (such as a linear decomposition described in more detail below) with respect to the ambisonic coefficients 11.

The spatial audio encoding device 20 may be configured to compress the ambisonic coefficients 11 using a decomposition involving application of a linear invertible transform (LIT). One example of the linear invertible transform is referred to as a “singular value decomposition” (or “SVD”), which may represent one form of a linear decomposition. In this example, the spatial audio encoding device 20 may apply SVD to the ambisonic coefficients 11 to determine a decomposed version of the ambisonic coefficients 11. The decomposed version of the ambisonic coefficients 11 may include one or more of predominant audio signals and one or more corresponding spatial components describing a direction, shape, and width of the associated predominant audio signals. The spatial audio encoding device 20 may analyze the decomposed version of the ambisonic coefficients 11 to identify various parameters, which may facilitate reordering of the decomposed version of the ambisonic coefficients 11.

The spatial audio encoding device 20 may reorder the decomposed version of the ambisonic coefficients 11 based on the identified parameters, where such reordering, as described in further detail below, may improve coding efficiency given that the transformation may reorder the ambisonic coefficients across frames of the ambisonic coefficients (where a frame commonly includes M samples of the decomposed version of the ambisonic coefficients 11 and M is, in some examples, set to 1024). After reordering the decomposed version of the ambisonic coefficients 11, the spatial audio encoding device 20 may select those of the decomposed version of the ambisonic coefficients 11 representative of foreground (or, in other words, distinct, predominant or salient) components of the soundfield. The spatial audio encoding device 20 may specify the decomposed version of the ambisonic coefficients 11 representative of the foreground components as an audio object (which may also be referred to as a “predominant sound signal,” or a “predominant sound component”) and associated directional information (which may also be referred to as a “spatial component” or, in some instances, as a so-called “V-vector”).

The spatial audio encoding device 20 may next perform a soundfield analysis with respect to the ambisonic coefficients 11 in order to, at least in part, identify the ambisonic coefficients 11 representative of one or more background (or, in other words, ambient) components of the soundfield. The spatial audio encoding device 20 may perform energy compensation with respect to the background components given that, in some examples, the background components may only include a subset of any given sample of the ambisonic coefficients 11 (e.g., such as those corresponding to zero and first order spherical basis functions and not those corresponding to second or higher order spherical basis functions). When order-reduction is performed, in other words, the spatial audio encoding device 20 may augment (e.g., add/subtract energy to/from) the remaining background ambisonic coefficients of the ambisonic coefficients 11 to compensate for the change in overall energy that results from performing the order reduction.

The spatial audio encoding device 20 may perform a form of interpolation with respect to the foreground directional information and then perform an order reduction with respect to the interpolated foreground directional information to generate order reduced foreground directional information. The spatial audio encoding device 20 may further perform, in some examples, a quantization with respect to the order reduced foreground directional information, outputting coded foreground directional information. In some instances, this quantization may comprise a scalar/entropy quantization. The spatial audio encoding device 20 may then output the intermediately formatted audio data 15 as the background components, the foreground audio objects, and the quantized directional information.

The background components and the foreground audio objects may comprise pulse code modulated (PCM) transport channels in some examples. That is, the spatial audio encoding device 20 may output a transport channel for each frame of the ambisonic coefficients 11 that includes a respective one of the background components (e.g., M samples of one of the ambisonic coefficients 11 corresponding to the zero or first order spherical basis function) and for each frame of the foreground audio objects (e.g., M samples of the audio objects decomposed from the ambisonic coefficients 11). The spatial audio encoding device 20 may further output side information (which may also be referred to as “sideband information”) that includes the spatial components corresponding to each of the foreground audio objects. Collectively, the transport channels and the side information may be represented in the example of FIG. 1 as the intermediately formatted audio data 15. In other words, the intermediately formatted audio data 15 may include the transport channels and the side information.

The spatial audio encoding device 20 may then transmit or otherwise output the intermediately formatted audio data 15 to psychoacoustic audio encoding device 406. The psychoacoustic audio encoding device 406 may perform psychoacoustic audio encoding with respect to the intermediately formatted audio data 15 to generate a bitstream 21. The content creator system 12 may then transmit the bitstream 21 via a transmission channel to the content consumer 14.

In some examples, the psychoacoustic audio encoding device 406 may represent multiple instances of a psychoacoustic audio coder, each of which is used to encode a transport channel of the intermediately formatted audio data 15. In some instances, this psychoacoustic audio encoding device 406 may represent one or more instances of an advanced audio coding (AAC) encoding unit or any type of AptX audio encoding unit. The psychoacoustic audio coder unit 406 may, in some instances, invoke an instance of an AAC encoding unit or the AptX encoding unit for each transport channel of the intermediately formatted audio data 15.

More information regarding how the background spherical harmonic coefficients may be encoded using an AAC encoding unit can be found in a convention paper by Eric Hellerud, et al., entitled “Encoding Higher Order Ambisonics with AAC,” presented at the 124^{th} Convention, 2008 May 17-20 and available at: http://ro.uow.edu.au/cgi/viewcontent.cgi?article=8025&context=engpapers. In some instances, the psychoacoustic audio encoding device 406 may audio encode various transport channels (e.g., transport channels for the background ambisonic coefficients) of the intermediately formatted audio data 15 using a lower target bitrate than that used to encode other transport channels (e.g., transport channels for the foreground audio objects) of the intermediately formatted audio data 15.

While shown in FIG. 1 as being directly transmitted to the content consumer 14, the content creator system 12 may output the bitstream 21 to an intermediate device positioned between the content creator system 12 and the content consumer 14. The intermediate device may store the bitstream 21 for later delivery to the content consumer 14, which may request this bitstream. The intermediate device may comprise a file server, a web server, a desktop computer, a laptop computer, a tablet computer, a mobile phone, a smart phone, or any other device capable of storing the bitstream 21 for later retrieval by an audio decoder. The intermediate device may reside in a content delivery network capable of streaming the bitstream 21 (and possibly in conjunction with transmitting a corresponding video data bitstream) to subscribers, such as the content consumer 14, requesting the bitstream 21.

Alternatively, the content creator system 12 may store the bitstream 21 to a storage medium, such as a compact disc, a digital video disc, a high definition video disc or other storage media, most of which are capable of being read by a computer and therefore may be referred to as computer-readable storage media or non-transitory computer-readable storage media. In this context, the transmission channel may refer to those channels by which content stored to these mediums are transmitted (and may include retail stores and other store-based delivery mechanism). In any event, the techniques of this disclosure should not therefore be limited in this respect to the example of FIG. 1.

As further shown in the example of FIG. 1, the content consumer 14 includes the audio playback system 16. The audio playback system 16 may represent any audio playback system capable of playing back multi-channel audio data. The audio playback system 16 may include a number of different audio renderers 22. The audio renderers 22 may each provide for a different form of rendering, where the different forms of rendering may include one or more of the various ways of performing vector-base amplitude panning (VBAP), and/or one or more of the various ways of performing soundfield synthesis.

The audio playback system 16 may further include an audio decoding device 24. The audio decoding device 24 may represent a device configured to decode ambisonic coefficients 11′ from the bitstream 21, where the ambisonic coefficients 11′ may be similar to the ambisonic coefficients 11 but differ due to lossy operations (e.g., quantization) and/or transmission via the transmission channel.

That is, the audio decoding device 24 may dequantize the foreground directional information specified in the bitstream 21, while also performing psychoacoustic decoding with respect to the foreground audio objects specified in the bitstream 21 and the encoded ambisonic coefficients representative of background components. The audio decoding device 24 may further perform interpolation with respect to the decoded foreground directional information and then determine the ambisonic coefficients representative of the foreground components based on the decoded foreground audio objects and the interpolated foreground directional information. The audio decoding device 24 may then determine the ambisonic coefficients 11′ based on the determined ambisonic coefficients representative of the foreground components and the decoded HOA coefficients representative of the background components.

The audio playback system 16 may, after decoding the bitstream 21 to obtain the ambisonic coefficients 11′, render the ambisonic coefficients 11′ to output speaker feeds 25. The audio playback system 16 may output speaker feeds 25 to one or more of speakers 3. The speaker feeds 25 may drive the speakers 3. The speakers 3 may represent loudspeakers (e.g., transducers placed in a cabinet or other housing), headphone speakers, or any other type of transducer capable of emitting sounds based on electrical signals.

To select the appropriate renderer or, in some instances, generate an appropriate renderer, the audio playback system 16 may obtain loudspeaker information 13 indicative of a number of the speakers 3 and/or a spatial geometry of the speakers 3. In some instances, the audio playback system 16 may obtain the loudspeaker information 13 using a reference microphone and driving the speakers 3 in such a manner as to dynamically determine the speaker information 13. In other instances or in conjunction with the dynamic determination of the speaker information 13, the audio playback system 16 may prompt a user to interface with the audio playback system 16 and input the speaker information 13.

The audio playback system 16 may select one of the audio renderers 22 based on the speaker information 13. In some instances, the audio playback system 16 may, when none of the audio renderers 22 are within some threshold similarity measure (in terms of the loudspeaker geometry) to that specified in the speaker information 13, generate the one of audio renderers 22 based on the speaker information 13. The audio playback system 16 may, in some instances, generate the one of audio renderers 22 based on the speaker information 13 without first attempting to select an existing one of the audio renderers 22.

While described with respect to speaker feeds 25, the audio playback system 16 may render headphone feeds from either the speaker feeds 25 or directly from the ambisonic coefficients 11′, outputting the headphone feeds to headphone speakers. The headphone feeds may represent binaural audio speaker feeds, which the audio playback system 16 renders using a binaural audio renderer.

The spatial audio encoding device 20 may encode (or, in other words, compress) the ambisonic audio data into a variable number of transport channels, each of which is allocated some amount of the bitrate using various bitrate allocation mechanisms. One example bitrate allocation mechanism allocates an equal number of bits to each transport channel. Another example bitrate allocation mechanism allocates bits to each of the transport channels based on an energy associated with each transport channel after each of the transport channels undergo gain control to normalize the gain of each of the transport channels.

The spatial audio encoding device 20 may provide transport channels 17 to the bitrate allocation unit 402 such that the bitrate allocation unit 402 may perform a number of different bitrate allocation mechanisms that may preserve the fidelity of the soundfield represented by each of transport channels. In this way, the spatial audio encoding device 20 may potentially avoid the introduction of audio artifacts while allowing for accurate perception of the soundfield from the various spatial directions.

The spatial audio encoding device 20 may output the transport channels 17 prior to performing gain control with respect to the transport channels 17. Alternatively, the spatial audio encoding device 20 may output the transport channels 17 after performing gain control, which the bitrate allocation unit 402 may undo through application of inverse gain control with respect to the transport channels 17 prior to performing one of the various bitrate allocation mechanisms.

In one example bitrate allocation mechanism, the bitrate allocation unit 402 may perform an energy analysis with respect to each of the transport channels 17 prior to application of gain control to normalize gain associated with each of the transport channels 17. Gain normalization may impact bitrate allocation as such normalization may result in each of the transport channels 17 being considered of equal importance (as energy is measured based, in large part, on gain).

As such, performing energy-based bitrate allocation with respect to gain normalized transport channels 17 may result in nearly the same number of bits being allocated to each of the transport channels 17. Performing energy-based bitrate allocation with respect to the transport channels 17, prior to gain control (or after reversing gain control through application of inverse gain control to the transport channels 17), may thereby result in improved bitrate allocation that more accurately reflects the importance of each of the transport channels 17 in providing information relevant in describing the soundfield.

In another bitrate allocation mechanism, the bitrate allocation unit 402 may allocate bits to each of the transport channels 17 based on a spatial analysis of each of the transport channels 17. The bitrate allocation unit 402 may render each of the transport channels 17 to one or more spatial domain channels (which may be another way to refer to one or more loudspeaker feeds for a corresponding one or more loudspeakers at different spatial locations).

As an alternative to or in conjunction with the energy analysis, the bitrate allocation unit 402 may perform a perceptual entropy based analysis of the rendered spatial domain channels (for each of the transport channels 17) to identify to which of the transport channels 17 to allocate a respectively greater or lesser number of bits. In some instances, the bitrate allocation unit 402 may supplement the perceptual entropy based analysis with a direction based weighting in which foregoing sounds are identified and allocated more bits relative to background sounds. The audio encoder may perform the direction based weighting and then perform the perceptual entropy based analysis to further refine the bit allocation to each of the transport channels 17.

In this respect, the bitrate allocation unit 402 may represent a unit configured to perform a bitrate allocation, based on an analysis (e.g., any combination of energy-based analysis, perceptual-based analysis, and/or directional-based weighting analysis) of transport channels 17 and prior to performing gain control with respect to the transport channels 17 or after performing inverse gain control with respect to the transport channels 17, to allocate bits to each of the transport channels 17. As a result of the bitrate allocation, the bitrate allocation unit 402 may determine a bitrate allocation schedule 19 indicative of a number of bits to be allocated to each of the transport channels 17. The bitrate allocation unit 402 may output the bitrate allocation schedule 19 to the psychoacoustic audio encoding device 406.

The psychoacoustic audio encoding device 406 may perform psychoacoustic audio encoding to compress each of the transport channels 17 until each of the transport channels 17 reaches the number of bits set forth in the bitrate allocation schedule 19. The psychoacoustic audio encoding device 406 may then specify the compressed version of each of the transport channels 19 in bitstream 21. As such, the psychoacoustic audio encoding device 406 may generate the bitstream 21 that specifies each of the transport channels 17 using the allocated number of bits.

The psychoacoustic audio encoding device 406 may specify, in the bitstream 21, the bitrate allocation per transport channel (which may also be referred to as the bitrate allocation schedule 19), which the audio decoding device 24 may parse from the bitstream 21. The audio decoding device 24 may then parse the transport channels 17 from the bitstream 21 based on the parsed bitrate allocation schedule 19, and thereby decode the HOA audio data set forth in each of the transport channels 17.

The audio decoding device 24 may, after parsing the compressed version of the transport channels 17, decode each of the compressed version of the transport channels 17 in two different ways. First, the audio decoding device 24 may perform psychoacoustic audio decoding with respect to each of the transport channels 17 to decompress the compressed version of the transport channels 17 and generate a spatially compressed version of the HOA audio data 15. Next, the audio decoding device 24 may perform spatial decompression with respect to the spatially compressed version of the HOA audio data 15 to generate (or, in other words, reconstruct) the HOA audio data 11′. The prime notation of the HOA audio data 11′ denotes that the HOA audio data 11′ may vary to some extent form the originally-captured HOA audio data 11 due to lossy compression, such as quantization, prediction, etc.

More information concerning decompression as performed by the audio decoding device 24 may be found in U.S. Pat. No. 9,489,955, entitled “Indicating Frame Parameter Reusability for Coding Vectors,” issued Nov. 8, 2016, and having an effective filing date of Jan. 30, 2014. Additional information concerning decompression as performed by the audio decoding device 24 may also be found in U.S. Pat. No. 9,502,044, entitled “Compression of Decomposed Representations of a Sound Field,” issued Nov. 22, 2016, and having an effective filing date of May 29, 2013. Furthermore, the audio decoding device 24 may be generally configured to operate as set forth in the above noted 3D Audio standard.

As noted above, the spatial audio encoding device 20 may encode many different types of audio data using the MPEG-H 3D audio coding standard, including object-based audio data (an example of which is a pulse-code modulated—PCM—audio object). At page 3, the MPEG-H 3D audio coding standard shows (in FIG. 1) objects being output via separate transport channels. The spatial audio encoding device 20 may specify audio metadata that includes one or more identifiers relevant to rendering of the object-based audio data to one or more speaker feeds.

The MPEG-H 3D audio coding standard currently provides one or more indications (an example of which is a syntax element) that defines a fixed or static range of values for adapting the rendering of the corresponding object-based audio data. For example, Table 132 of the MPEG-H 3D audio coding standard identifies fixed ranges for location information that identifies a location of the object-based audio data relative to a listener (which may also be referred to as the so-called “sweet spot”). The location information may be defined as one or more polar coordinates including, as shown in Table 132 of the MPEG-H 3D audio coding standard, an azimuth angle, an elevation angle, and a radius.

The Audio Definition Model (ADM) set forth in International Telecommunication Union (ITU) Recommendation (ITU-R) BS.2076-1, entitled “Audio Definition Model,” and dated June, 2017 suffers from the same issues, in terms of utilizing fixed ranges. For example, Table 15 of the ADM implicitly defines maximum values for cartesian coordinates X, Y, and Z (normalized or unnormalized) that define location information for associated object-based audio data (in that only so many bits are available to represent the values for the cartesian coordinates).

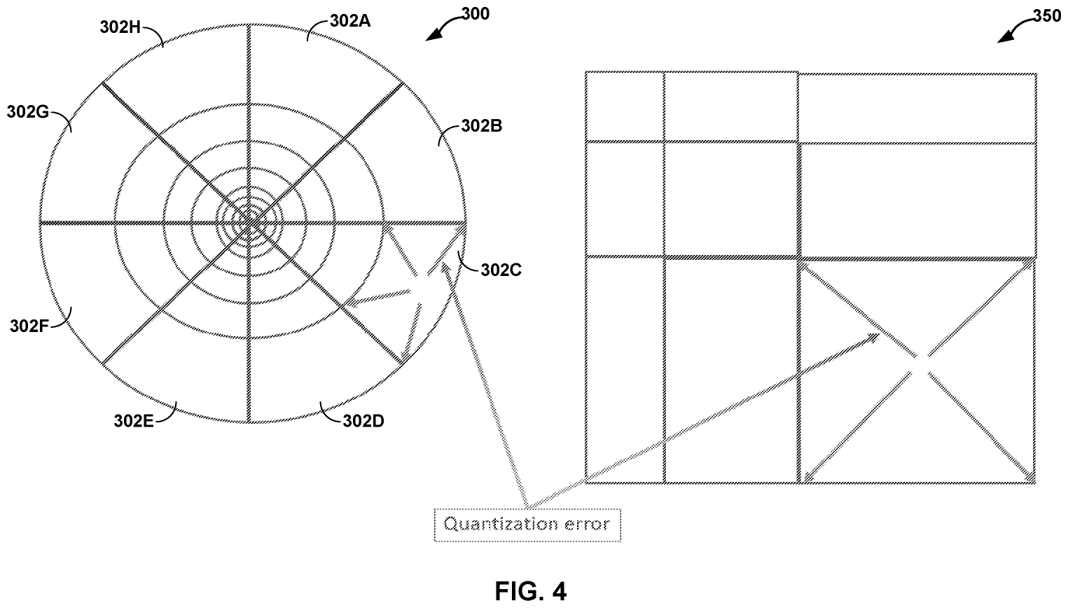

However, the fixed range for the various location information noted above is limited, providing a max value for the radius of polar coordinates and maximum values for cartesian coordinates. Furthermore, both the MPEG-H 3D audio coding standard and the ADM may utilize a non-uniform resolution over space, using “log-like” quantization levels to create non-uniform quantization over the range so that smaller values of the radius for polar coordinates (and likewise smaller values for the X, Y, and Z cartesian coordinates) provide more precision (or, in other words, undergo less quantization) and larger values experience more quantization noise. Both of these issues are illustrated in the example shown in FIG. 4.

FIG. 4 is a diagram illustrating how statically defined audio metadata may impact encoding and decoding of audio data. As shown in the example of FIG. 4, a cross section of the polar coordinate space is represented by a circle 300, while a cross section of the cartesian coordinate space is represented by a square 350.

The circle 300 is subdivided along the azimuth into 8 different pie slices 302A-302H. The circle 300 is also subdivided along the radius to form the inner circles. The combination of the two subdivisions form quantization regions. The closer to the center of the circle 300, the less quantization error exists. The farther from the center of the circle 300 (and hence the larger the value), the more quantization error that is injected into the representation of the audio data (or, in other words, bitstream). The same issues exist with respect to the cartesian coordinates space represented by square 350, where the further out from the top left corner of square 350 results in potentially more quantization error.

Returning back to FIG. 1, the spatial audio encoding device 20 may recursively specify, in the bitstream 15 (which is another way of referring to the spatially compressed HOA audio data 15), audio metadata associated with the audio data in accordance with various aspects of the techniques described in this disclosure. Recursive specification of the audio metadata may refer to an iterative form of specifying audio metadata in which a function for specifying a portion of the audio metadata may indicate whether the function for specifying the portion of the audio data is to be invoked again to specify another portion (e.g., a second portion) of the audio metadata, where recursion is considered from the computer science perspective where a function invokes itself (often creating a stack to store state that is later popped off the stack when control returns to different iterations of the functions).

The following pseudocode provides one example way by which the spatial audio encoding device 20 may recursively specify, in the bitstream 15, the audio metadata associated with the audio data (where in this example, the audio data is represented by the ambisonic coefficients 11 or the compressed version thereof).

| new_metadata_syntax( ) | |
|---|---|
| { | |
| isNested; | 1 bit |

while (isNested){

new_metadata_syntax( );

}
radius;
azimuth;
elevation;
...
}

In the above pseudocode, the spatial audio encoding device 20 may invoke the recursive function new_metadata_syntax( ), which includes a nested indication (e.g., an isNested syntax element) that identifies whether the bitstream 15 includes additional audio metadata (or, in other words, a second portion of the recursively defined audio metadata). The spatial audio encoding device 20 may set the isNested syntax element to one (1) when there is additional audio metadata specified in the bitstream 15. As such, per the while loop in the pseudocode above, the spatial audio encoding device 20 may invoke the new_metadata_syntax( ) function repeatedly until no more additional audio metadata is to be specified in the bitstream 15.

Responsive to determining that no more additional audio metadata is available to be specified in the bitstream 15, the spatial audio encoding device 20 may set the isNested syntax element to zero (0) and proceed to specify a first portion of the recursively defined audio metadata, which is shown in the above pseudocode as polar coordinate indications (e.g., the radius, azimuth, and elevation syntax elements). The spatial audio encoding device 20 may proceed to return to the previously invoked new_metadata_syntax( ) function, specify the additional portions (e.g., a second portion) of the recursively defined audio metadata, returning to the previously invoked new_metadata_syntax( ) function, and repeat until all of the recursively defined audio metadata is specified in the bitstream 15. In this manner, the spatial audio encoding device 20 may recursively specify, in the bitstream 15, the audio metadata.

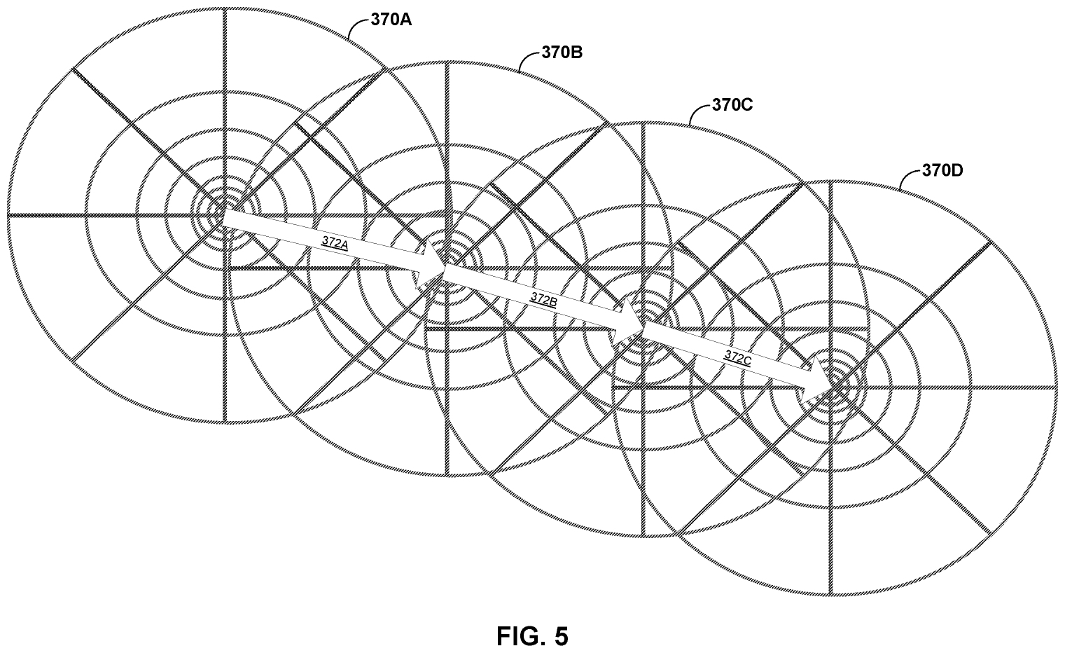

Each iteration of the audio metadata specified through invoking the new_metadata_syntax( ) function specifies another portion of the audio metadata that refines the previously specified portion of the recursively defined audio metadata. That is, a first invocation of the recursive function may specify a first portion of the recursively defined audio metadata (e.g., polar coordinates). A second invocation of the recursive function may specify a second portion of the recursively defined audio metadata that, when applied to the first portion of the recursively defined audio metadata, adjusts the location relative to the location identified by the first portion of the recursively defined audio metadata. More information regarding how the different portions of the audio data adjust the location of the previously specified portion is described below with respect to the example of FIG. 5.

FIG. 5 is a diagram illustrating how recursively defined audio metadata may promote potentially better representations of the audio data during encoding and decoding according to various aspects of the techniques described in this disclosure. As shown in the example of FIG. 5, each successive circle 370A-370D represents the polar coordinate space being extended by three additional portions of audio metadata. Each successive arrow 372A-372C shows how the additional portions of the audio metadata each adjust the location of the previously defined portion of the audio metadata, enabling more resolution and adaptability in specifying the audio metadata.

Although described above with respect to polar coordinates, the techniques may be applied with respect to any other coordinate system, including cartesian coordinates. Furthermore, the spatial audio encoding device 20 may specify, in the bitstream 15, one or more conversion indications indicating that the current audio metadata defined according to a first coordinate system is to be converted to a second (different) coordinate system. For example, the spatial audio encoding device 20 may specify, in the bitstream 15 one or more conversion indications indicating that the polar coordinates are to be converted to cartesian coordinates.

In any event, the audio decoding device 24 may operate in a manner reciprocal to that described above with respect to the spatial audio encoding device 20. As such, the audio decoding device 24 may obtain, from the bitstream 15 (which may refer to the psychoacoustically decoded version of the bitstream 21), the recursively defined audio metadata. That is, the audio decoding device 24 may invoke the recursive function identified in the pseudocode above, and when the nested indication indicates that the bitstream includes the second portion of the recursively defined audio metadata, invoke the recursive function to obtain the second portion of the recursively defined audio metadata, repeating until all of the portions of the audio metadata are extracted from the bitstream 15.

In this respect, the audio decoding device 24 is configured to recursively call, based on a nested indication indicating whether the bitstream 15 includes an additional portion of the recursively defined audio metadata, a function to obtain, from the bitstream 15, the additional portion of the recursively defined audio metadata. As noted above, each of the additional portions of the recursively defined audio metadata including an instance of the nested indication. The audio decoding device 24, after extracting all of the portions of the audio metadata, process the audio metadata to identify the location of the audio data relative to the listener.

The audio decoding device 24 may output the location as location 27, which the audio playback system 16 may utilize with regard to the renderers 22. As one example, the audio playback system 16 may select one of the renderers 22 based on the location 27. In another example, the audio playback system 16 may adapt one of the renderers 22 based on the location 27. In yet another example, the audio playback system 16 may generate a new renderer 22 based on the location 27.

The audio decoding device 24 may also obtain, from the bitstream 15, the representation of the audio data. The audio decoding device 24 may decode the representation of the audio data to obtain the audio data (which may comprise object-based audio data as discussed above). The audio decoding device 24 may then output the decoded audio data (shown in this example as the ambisonic coefficients 11′) to the renderers 22, where the audio playback system 16 may apply the one of the renderers 22 (discussed above) to the audio data 11′ to obtain one or more speaker feeds 25. The audio playback system 16 may output the speaker feeds 25 to one or more speakers 3.

In this way, rather than specify audio metadata in a static or fixed manner, which may limit precision of the audio metadata to some fixed or static range, various aspects of the techniques may enable an audio encoding device 20 to specify the audio metadata recursively to provide a dynamically adjustable range, while also potentially reducing error. As such, the techniques may enable audio encoders and audio decoders themselves to better encode audio data, as a higher range may permit better localization of the audio data, while also reducing the injection of error that may result in audio artifacts during playback.

Although discussed with respect to ambisonic coefficients 11′ (or other scene-based audio data), the audio metadata may apply to any other type of audio data, such as object-based audio data, channel-based audio data, etc. In some examples, the audio decoding device 24 may convert the ambisonic coefficients 11′ to object-based audio data, or channel-based audio data

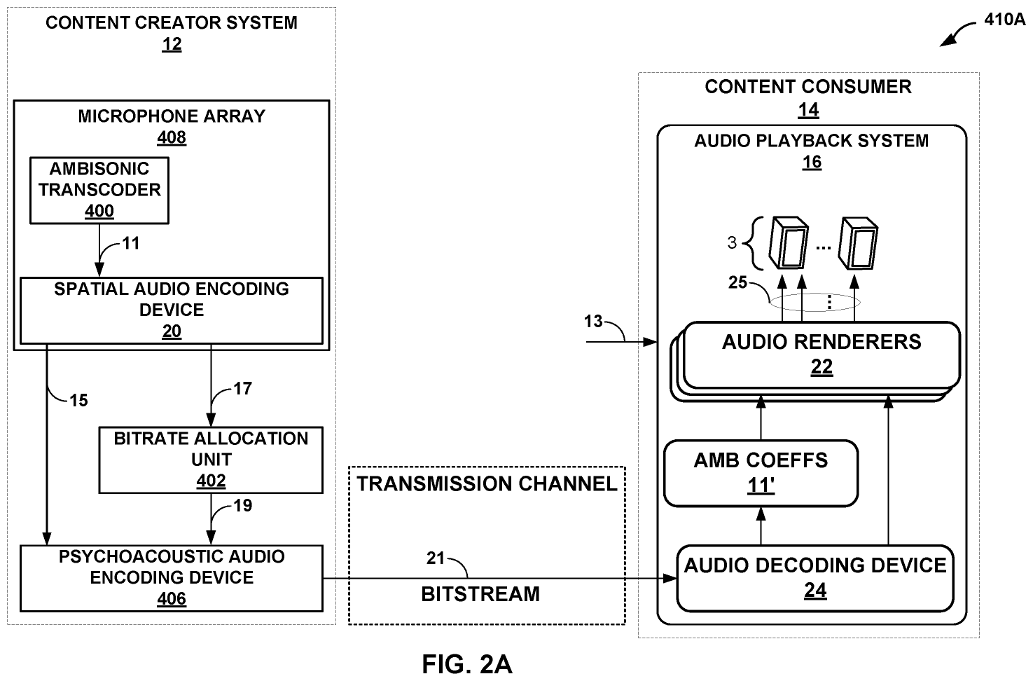

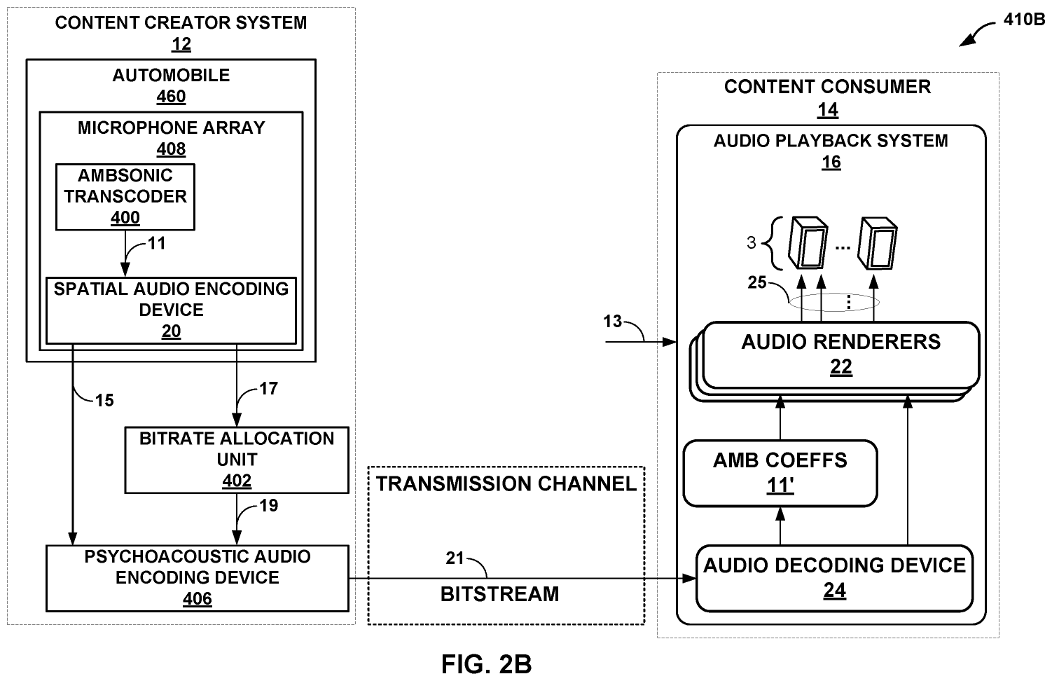

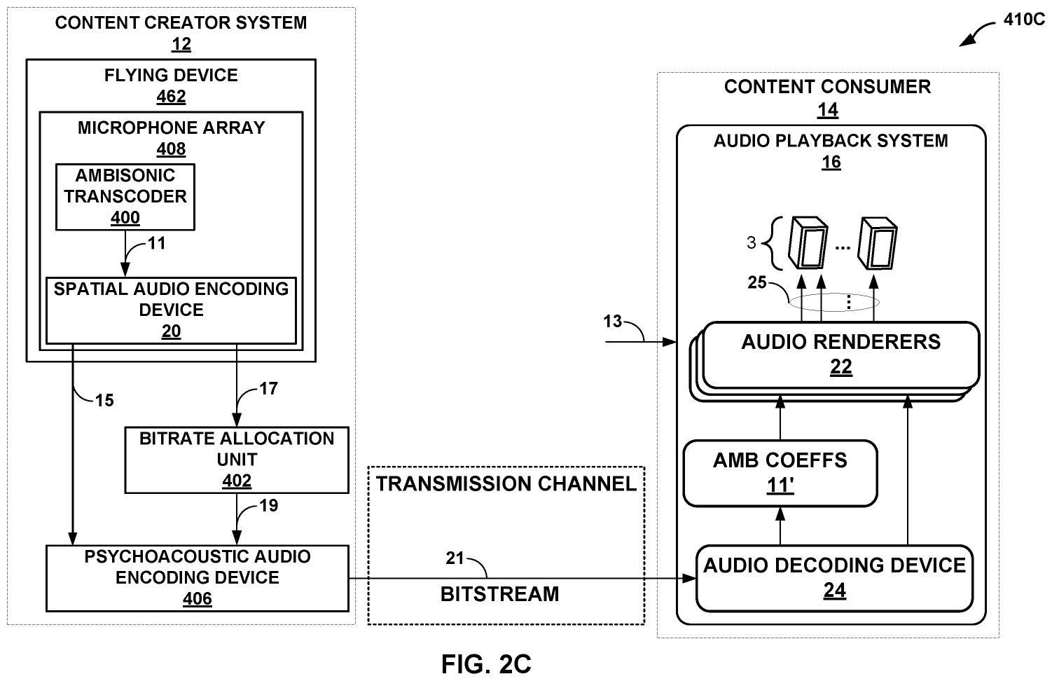

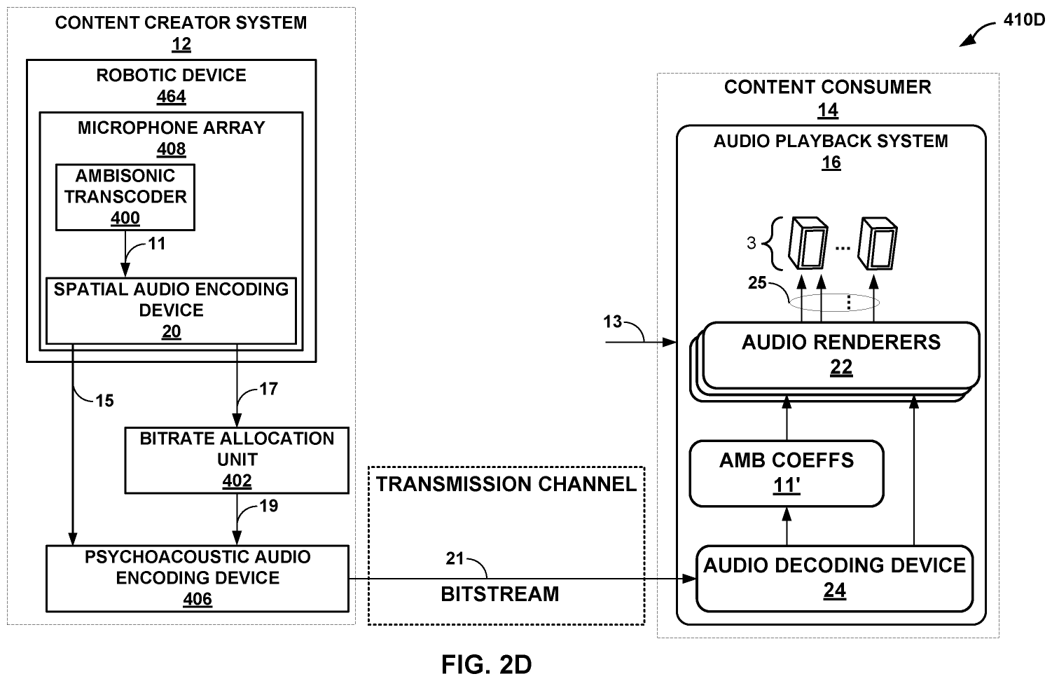

FIGS. 2A-2D are block diagrams illustrating different examples of a system that may be configured to perform various aspects of the techniques described in this disclosure. The system 410A shown in FIG. 2A is similar to the system 10 of FIG. 1, except that the microphone array 5 of the system 10 is replaced with a microphone array 408. The microphone array 408 shown in the example of FIG. 2A includes the ambisonic transcoder 400 and the spatial audio encoding device 20. As such, the microphone array 408 generates the spatially compressed ambisonic audio data 15, which is then compressed using the bitrate allocation in accordance with various aspects of the techniques set forth in this disclosure.

The system 410B shown in FIG. 2B is similar to the system 410A shown in FIG. 2A except that an automobile 460 includes the microphone array 408. As such, the techniques set forth in this disclosure may be performed in the context of automobiles.

The system 410C shown in FIG. 2C is similar to the system 410A shown in FIG. 2A except that a remotely-piloted and/or autonomous controlled flying device 462 includes the microphone array 408. The flying device 462 may for example represent a quadcopter, a helicopter, or any other type of drone. As such, the techniques set forth in this disclosure may be performed in the context of drones.

The system 410D shown in FIG. 2D is similar to the system 410A shown in FIG. 2A except that a robotic device 464 includes the microphone array 408. The robotic device 464 may for example represent a device that operates using artificial intelligence, or other types of robots. In some examples, the robotic device 464 may represent a flying device, such as a drone. In other examples, the robotic device 464 may represent other types of devices, including those that do not necessarily fly. As such, the techniques set forth in this disclosure may be performed in the context of robots.

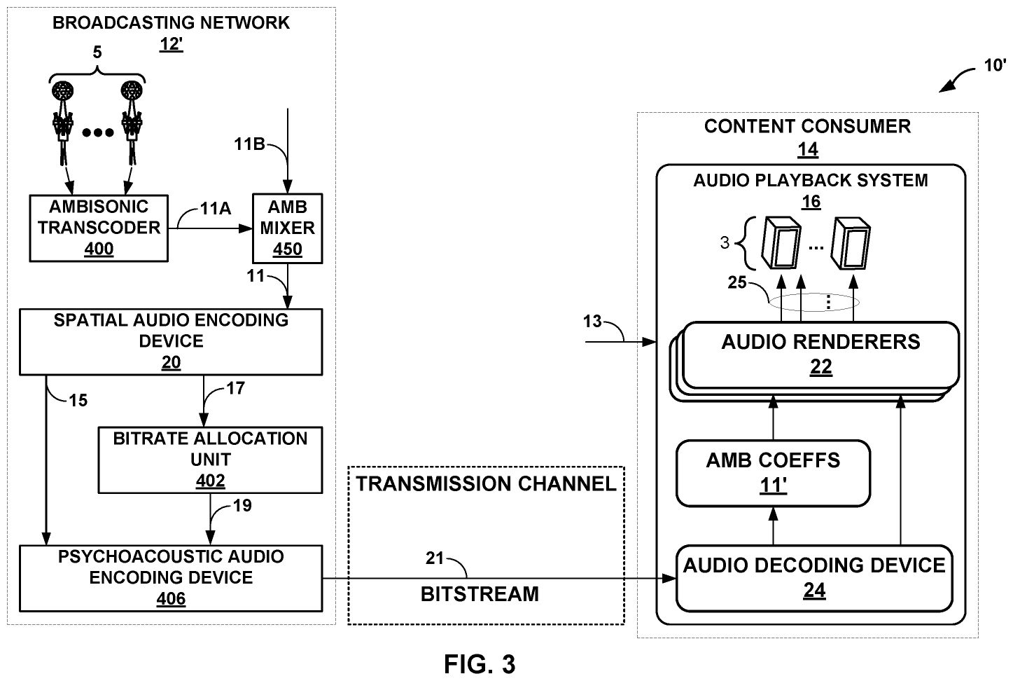

FIG. 3 is a block diagram illustrating another example of a system that may be configured to perform various aspects of the techniques described in this disclosure. The system shown in FIG. 3 is similar to the system 10 of FIG. 1 except that the content creation network 12 is a broadcasting network 12′, which also includes an additional ambisonic (“AMB”) mixer 450. As such, the system shown in FIG. 3 is denoted as system 10′ and the broadcast network of FIG. 3 is denoted as broadcast network 12′.

The ambisonic transcoder 400 may output the live feed ambisonic coefficients as ambisonic coefficients 11A to the ambisonic mixer 450. The ambisonic mixer 450 represents a device or unit configured to mix ambisonic audio data. The ambisonic mixer 450 may receive other ambisonic audio data 11B (which may be representative of any other type of audio data, including audio data captured with spot microphones or non-3D microphones and converted to the spherical harmonic domain, special effects specified in the ambisonic domain, etc.) and mix this ambisonic audio data 11B with the ambisonic audio data 11A to obtain the ambisonic coefficients 11.

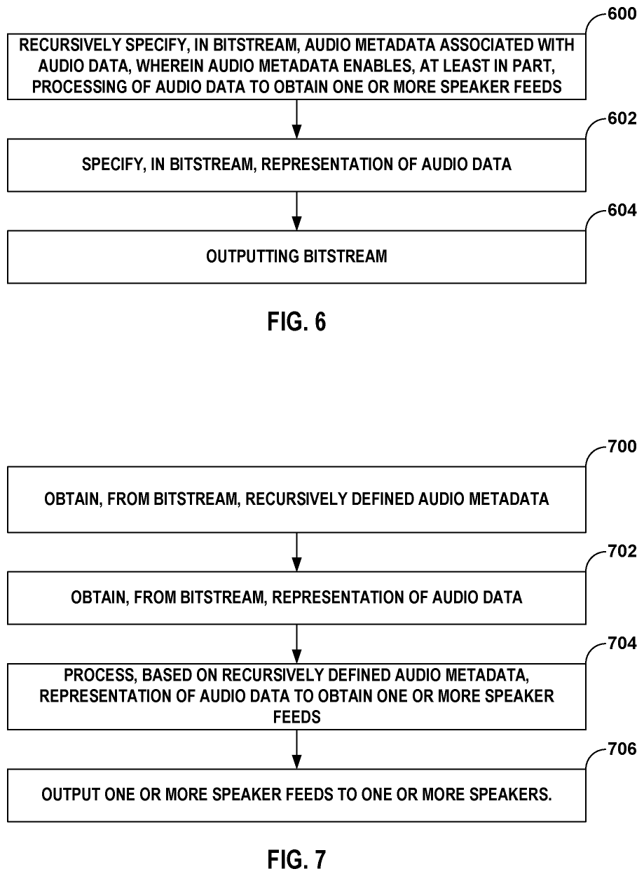

FIG. 6 is a flowchart illustrating example operation of the spatial audio encoding device shown in the example of FIG. 1 in performing various aspects of the techniques described in this disclosure. As described above, the spatial audio encoding device 20 may recursively specify, in the bitstream 15, audio metadata associated with the audio data 11, the audio metadata enabling, at least in part, processing of the audio data 11 to obtain one or more speaker feeds 25 (600). The spatial audio encoding device 20 may specify, in the bitstream 15, a representation of the audio data 11 (602). The spatial audio encoding device 20 may output the bitstream 15 (604).

FIG. 7 is a flowchart illustrating example operation of the audio decoding device shown in the example of FIG. 1 in performing various aspects of the techniques described in this disclosure. The audio decoding device 24 may obtain, from the bitstream 21, recursively defined audio metadata (700). The audio decoding device 24 may obtain, from the bitstream 21, a representation of the audio data 11 (as the ambisonic coefficients 11′) (702). The audio decoding device 24 may process (assuming, in this example, that the audio decoding device 24 includes the audio renderers 22), based on the recursively defined audio metadata, the representation of the audio data 11 to obtain one or more speaker feeds 25 (704). The audio playback system 16 may output the one or more speaker feeds 25 to one or more speakers 3 (706).

In some contexts, such as broadcasting contexts, the audio encoding device may be split into a spatial audio encoder, which performs a form of intermediate compression with respect to the ambisonic representation that includes gain control, and a psychoacoustic audio encoder 406 (which may also be referred to as a “perceptual audio encoder 406”) that performs perceptual audio compression to reduce redundancies in data between the gain normalized transport channels. In these instances, the bitrate allocation unit 402 may perform inverse gain control to recover the original transport channel 17, where the psychoacoustic audio encoding device 406 may perform the energy-based bitrate allocation, directional bitrate allocation, perceptual based bitrate allocation, or some combination thereof based on bitrate schedule 19 in accordance with various aspects of the techniques described in this disclosure.

Although described in this disclosure with respect to the broadcasting context, the techniques may be performed in other contexts, including the above noted automobiles, drones, and robots, as well as, in the context of a mobile communication handset or other types of mobile phones, including smart phones (which may also be used as part of the broadcasting context).

In addition, the foregoing techniques may be performed with respect to any number of different contexts and audio ecosystems and should not be limited to any of the contexts or audio ecosystems described above. A number of example contexts are described below, although the techniques should be limited to the example contexts. One example audio ecosystem may include audio content, movie studios, music studios, gaming audio studios, channel based audio content, coding engines, game audio stems, game audio coding/rendering engines, and delivery systems.

The movie studios, the music studios, and the gaming audio studios may receive audio content. In some examples, the audio content may represent the output of an acquisition. The movie studios may output channel based audio content (e.g., in 2.0, 5.1, and 7.1) such as by using a digital audio workstation (DAW). The music studios may output channel based audio content (e.g., in 2.0, and 5.1) such as by using a DAW. In either case, the coding engines may receive and encode the channel based audio content based one or more codecs (e.g., AAC, AC3, Dolby True HD, Dolby Digital Plus, and DTS Master Audio) for output by the delivery systems. The gaming audio studios may output one or more game audio stems, such as by using a DAW. The game audio coding/rendering engines may code and or render the audio stems into channel based audio content for output by the delivery systems. Another example context in which the techniques may be performed comprises an audio ecosystem that may include broadcast recording audio objects, professional audio systems, consumer on-device capture, HOA audio format, on-device rendering, consumer audio, TV, and accessories, and car audio systems.

The broadcast recording audio objects, the professional audio systems, and the consumer on-device capture may all code their output using ambi sonic audio format (such as the HOA audio format). In this way, the audio content may be coded using the ambisonic audio format into a single representation that may be played back using the on-device rendering, the consumer audio, TV, and accessories, and the car audio systems. In other words, the single representation of the audio content may be played back at a generic audio playback system (i.e., as opposed to requiring a particular configuration such as 5.1, 7.1, etc.), such as audio playback system 16.

Various aspects of the techniques may enable the examples set forth in the following clauses:

Clause 1A. A device configured to process a bitstream representative of audio data that describes a soundfield, the device comprising: one or more memories configured to store at least a portion of the bitstream; one or more processors configured to: obtain, from the bitstream, recursively defined audio metadata; obtain, from the bitstream, a representation of the audio data; process, based on the recursively defined audio metadata, the representation of the audio data to obtain one or more speaker feeds; and output the one or more speaker feeds to one or more speakers.

Clause 2A. The device of clause 1A, wherein the representation of the audio data includes object-based audio data, and wherein the recursively defined audio metadata includes object metadata descriptive of the object-based audio data.

Clause 3A. The device of any combination of clauses 1A and 2A, wherein the representation of the audio data includes object-based audio data, and wherein the recursively defined audio metadata includes object metadata identifying of a location of the object-based audio data relative to a location of a listener.

Clause 4A. The device of any combination of clauses 1A-3A, wherein the representation of the audio data includes object-based audio data, and wherein the recursively defined audio metadata includes object metadata identifying a location of the object-based audio data relative to a location of a listener as one or more polar coordinates.

Clause 5A. The device of clause 4A, wherein the one or more processors are further configured to: obtain, from the bitstream, a conversion indication indicating that the one or more polar coordinates are to be converted into one or more cartesian coordinates; and convert, responsive to the conversion indication, the one or more polar coordinates to the one or more cartesian coordinates, and wherein the one or more processors are configured to process, based on the one or more cartesian coordinates, the representation of the audio data to obtain the audio data.

Clause 6A. The device of any combination of clauses 1A-3A, wherein the recursively defined audio metadata includes object metadata identifying a location of object-based audio data relative to a location of a listener as one or more cartesian coordinates.

Clause 7A. The device of any combination of clauses 1A-6A, wherein the one or more processors are configured to: obtain, from the bitstream, a first portion of the recursively defined audio metadata, the first portion of the recursively defined audio metadata including a nested indication indicating whether the bitstream includes a second portion of the recursively defined audio metadata; and obtain, from the bitstream and responsive to the nested indication indicating that bitstream includes the second portion of the recursively defined audio metadata, the second portion of the recursively defined audio metadata.

Clause 8A. The device of any combination of clauses 1A-6A, wherein the one or more processors are configured to recursively call, based on a nested indication indicating whether the bitstream includes an additional portion of the recursively defined audio metadata, a function to obtain, from the bitstream, the additional portion of the recursively defined audio metadata, each of the additional portions of the recursively defined audio metadata including an instance of the nested indication.

Clause 9A. The device of clause 8A, wherein the recursively defined audio metadata identifies a location of the audio data relative to a listener, and wherein each of the additional portions of the recursively defined audio metadata adjusts the location of the audio data relative to a previous location identified by a previous additional portion of the recursively defined audio metadata.

Clause 10A. The device of any combination of clauses 1A-8A, wherein the representation of the audio data comprises object-based audio data, and wherein the one or more processors are configured to render, based on the recursively defined audio metadata, the object-based audio data to obtain the one or more speaker feeds.

Clause 11A. A method of processing a bitstream representative of audio data that describes a soundfield, the method comprising: obtaining, from the bitstream, recursively defined audio metadata; obtaining, from the bitstream, a representation of the audio data; processing, based on the recursively defined audio metadata, the representation of the audio data to obtain one or more speaker feeds; and outputting the one or more speaker feeds to one or more speakers.

Clause 12A. The method of clause 11A, wherein the representation of the audio data includes object-based audio data, and wherein the recursively defined audio metadata includes object metadata descriptive of the object-based audio data.

Clause 13A. The method of any combination of clauses 11A and 12A, wherein the representation of the audio data includes object-based audio data, and wherein the recursively defined audio metadata includes object metadata identifying of a location of the object-based audio data relative to a location of a listener.

Clause 14A. The method of any combination of clauses 11A-13A, wherein the representation of the audio data includes object-based audio data, and wherein the recursively defined audio metadata includes object metadata identifying a location of the object-based audio data relative to a location of a listener as one or more polar coordinates.

Clause 15A. The method of clause 14A, further comprising: obtaining, from the bitstream, a conversion indication indicating that the one or more polar coordinates are to be converted into one or more cartesian coordinates; and converting, responsive to the conversion indication, the one or more polar coordinates to the one or more cartesian coordinates, and wherein processing the representation of the audio data comprises processing, based on the one or more cartesian coordinates, the representation of the audio data to obtain the audio data.

Clause 16A. The method of any combination of clauses 11A-13A, wherein the recursively defined audio metadata includes object metadata identifying a location of object-based audio data relative to a location of a listener as one or more cartesian coordinates.

Clause 17A. The method of any combination of clauses 11A-16A, wherein obtaining the recursively defined audio metadata comprises: obtaining, from the bitstream, a first portion of the recursively defined audio metadata, the first portion of the recursively defined audio metadata including a nested indication indicating whether the bitstream includes a second portion of the recursively defined audio metadata; and obtaining, from the bitstream and responsive to the nested indication indicating that bitstream includes the second portion of the recursively defined audio metadata, the second portion of the recursively defined audio metadata.

Clause 18A. The method of any combination of clauses 11A-16A, wherein obtaining the recursively defined audio metadata includes recursively calling, based on a nested indication indicating whether the bitstream includes an additional portion of the recursively defined audio metadata, a function to obtain, from the bitstream, the additional portion of the recursively defined audio metadata, each of the additional portions of the recursively defined audio metadata including an instance of the nested indication.

Clause 19A. The method of clause 18A, wherein the recursively defined audio metadata identifies a location of the audio data relative to a listener, and wherein each of the additional portions of the recursively defined audio metadata adjusts the location of the audio data relative to a previous location identified by a previous additional portion of the recursively defined audio metadata.

Clause 20A. The method of any combination of clauses 11A-18A, wherein the representation of the audio data comprises object-based audio data, and wherein processing the representation of the audio data comprises rendering, based on the recursively defined audio metadata, the object-based audio data to obtain the one or more speaker feeds.

Clause 21A. A device configured to process a bitstream representative of audio data that describes a soundfield, the device comprising: means for obtaining, from the bitstream, recursively defined audio metadata; means for obtaining, from the bitstream, a representation of the audio data; means for processing, based on the recursively defined audio metadata, the representation of the audio data to obtain one or more speaker feeds; and means for outputting the one or more speaker feeds to one or more speakers.

Clause 22A. The device of clause 21A, wherein the representation of the audio data includes object-based audio data, and wherein the recursively defined audio metadata includes object metadata descriptive of the object-based audio data.

Clause 23A. The device of any combination of clauses 21A and 22A, wherein the representation of the audio data includes object-based audio data, and wherein the recursively defined audio metadata includes object metadata identifying of a location of the object-based audio data relative to a location of a listener.

Clause 24A. The device of any combination of clauses 21A-23A, wherein the representation of the audio data includes object-based audio data, and wherein the recursively defined audio metadata includes object metadata identifying a location of the object-based audio data relative to a location of a listener as one or more polar coordinates.

Clause 25A. The device of clause 24A, further comprising: means for obtaining, from the bitstream, a conversion indication indicating that the one or more polar coordinates are to be converted into one or more cartesian coordinates; and means for converting, responsive to the conversion indication, the one or more polar coordinates to the one or more cartesian coordinates, and wherein the means for processing the representation of the audio data comprises means for processing, based on the one or more cartesian coordinates, the representation of the audio data to obtain the audio data.

Clause 26A. The device of any combination of clauses 21A-23A, wherein the recursively defined audio metadata includes object metadata identifying a location of object-based audio data relative to a location of a listener as one or more cartesian coordinates.

Clause 27A. The device of any combination of clauses 21A-26A, wherein the means for obtaining the recursively defined audio metadata comprises: means for obtaining, from the bitstream, a first portion of the recursively defined audio metadata, the first portion of the recursively defined audio metadata including a nested indication indicating whether the bitstream includes a second portion of the recursively defined audio metadata; and means for obtaining, from the bitstream and responsive to the nested indication indicating that bitstream includes the second portion of the recursively defined audio metadata, the second portion of the recursively defined audio metadata.

Clause 28A. The device of any combination of clauses 21A-26A, wherein the means for obtaining the recursively defined audio metadata includes means for recursively calling, based on a nested indication indicating whether the bitstream includes an additional portion of the recursively defined audio metadata, a function to obtain, from the bitstream, the additional portion of the recursively defined audio metadata, each of the additional portions of the recursively defined audio metadata including an instance of the nested indication.

Clause 29A. The device of clause 28A, herein the recursively defined audio metadata identifies a location of the audio data relative to a listener, and wherein each of the additional portions of the recursively defined audio metadata adjusts the location of the audio data relative to a previous location identified by a previous additional portion of the recursively defined audio metadata.

Clause 30A. The device of any combination of clauses 21A-28A, wherein the representation of the audio data comprises object-based audio data, and wherein the means for processing the representation of the audio data comprises means for rendering, based on the recursively defined audio metadata, the object-based audio data to obtain the one or more speaker feeds.

Clause 31A. A non-transitory computer-readable storage medium having stored thereon instructions that, when executed, cause one or more processors to: obtain, from a bitstream representative of audio data that describes a soundfield, recursively defined audio metadata; obtaining, from the bitstream, a representation of the audio data; processing, based on the recursively defined audio metadata, the representation of the audio data to obtain one or more speaker feeds; and outputting the one or more speaker feeds to one or more speakers.

Clause 1B. A device configured to obtain a bitstream representative of audio data describing a soundfield, the device comprising: one or more memories configured to store the audio data; one or more processors configured to: recursively specify, in the bitstream, audio metadata associated with the audio data, the audio metadata enabling, at least in part, processing of the audio data to obtain one or more speaker feeds; specify, in the bitstream, a representation of the audio data; and output the bitstream.

Clause 2B. The device of clause 1B, wherein the representation of the audio data includes object-based audio data, and wherein the recursively defined audio metadata includes object metadata descriptive of the object-based audio data.

Clause 3B. The device of any combination of clauses 1B and 2B, wherein the representation of the audio data includes object-based audio data, and wherein the recursively defined audio metadata includes object metadata identifying of a location of the object-based audio data relative to a location of a listener.

Clause 4B. The device of any combination of clauses 1B-3B, wherein the representation of the audio data includes object-based audio data, and wherein the recursively defined audio metadata includes object metadata identifying a location of the object-based audio data relative to a location of a listener as one or more polar coordinates.

Clause 5B. The device of clause 4B, wherein the one or more processors are further configured to specify, in the bitstream, a conversion indication indicating that the one or more polar coordinates are to be converted into one or more cartesian coordinates.

Clause 6B. The device of any combination of clauses 1B-3B, wherein the recursively defined audio metadata includes object metadata identifying a location of object-based audio data relative to a location of a listener as one or more cartesian coordinates.

Clause 7B. The device of any combination of clauses 1B-6B, wherein the one or more processors are configured to: specify, in the bitstream, a first portion of the recursively defined audio metadata, the first portion of the recursively defined audio metadata including a nested indication indicating whether the bitstream includes a second portion of the recursively defined audio metadata; and specify, in the bitstream and when the nested indication indicates that bitstream includes the second portion of the recursively defined audio metadata, the second portion of the recursively defined audio metadata.

Clause 8B. The device of any combination of clauses 1B-6B, wherein the one or more processors are configured to recursively call, when a nested indication indicates that the bitstream includes an additional portion of the recursively defined audio metadata, a function to specify, in the bitstream, the additional portion of the recursively defined audio metadata, each of the additional portion of the recursively defined audio metadata including an instance of the nested indication.

Clause 9B. The device of clause 8B, wherein the recursively defined audio metadata identifies a location of the audio data relative to a listener, and wherein each of the additional portions of the recursively defined audio metadata adjusts the location of the audio data relative to a previous location identified by a previous additional portion of the recursively defined audio metadata.

Clause 10B. The device of any combination of clauses 1B-8B, wherein the one or more processors are configured to receive, from one or more microphones, the audio data.

Clause 11B. A method of obtaining a bitstream representative of audio data describing a soundfield, the device comprising: recursively specifying, in the bitstream, audio metadata associated with the audio data, the audio metadata enabling, at least in part, processing of the audio data to obtain one or more speaker feeds; specifying, in the bitstream, a representation of the audio data; and outputting the bitstream.

Clause 12B. The method of clause 11B, wherein the representation of the audio data includes object-based audio data, and wherein the recursively defined audio metadata includes object metadata descriptive of the object-based audio data.

Clause 13B. The method of any combination of clauses 11B and 12B, wherein the representation of the audio data includes object-based audio data, and wherein the recursively defined audio metadata includes object metadata identifying of a location of the object-based audio data relative to a location of a listener.

Clause 14B. The method of any combination of clauses 11B-13B, wherein the representation of the audio data includes object-based audio data, and wherein the recursively defined audio metadata includes object metadata identifying a location of the object-based audio data relative to a location of a listener as one or more polar coordinates.

Clause 15B. The method of clause 14B, further comprising specifying, in the bitstream, a conversion indication indicating that the one or more polar coordinates are to be converted into one or more cartesian coordinates.

Clause 16B. The method of any combination of clauses 11B-13B, wherein the recursively defined audio metadata includes object metadata identifying a location of object-based audio data relative to a location of a listener as one or more cartesian coordinates.

Clause 17B. The method of any combination of clauses 11B-16B, wherein recursively specifying the audio metadata comprises: specifying, in the bitstream, a first portion of the recursively defined audio metadata, the first portion of the recursively defined audio metadata including a nested indication indicating whether the bitstream includes a second portion of the recursively defined audio metadata; and specifying, in the bitstream and when the nested indication indicates that bitstream includes the second portion of the recursively defined audio metadata, the second portion of the recursively defined audio metadata.

Clause 18B. The method of any combination of clauses 11B-16B, wherein recursively specifying the audio metadata comprises recursively calling, when a nested indication indicates that the bitstream includes an additional portion of the recursively defined audio metadata, a function to specify, in the bitstream, the additional portion of the recursively defined audio metadata, each of the additional portion of the recursively defined audio metadata including an instance of the nested indication.

Clause 19B. The method of clause 18B, wherein the recursively defined audio metadata identifies a location of the audio data relative to a listener, and wherein each of the additional portions of the recursively defined audio metadata adjusts the location of the audio data relative to a previous location identified by a previous additional portion of the recursively defined audio metadata.

Clause 20B. The method of any combination of clauses 11B-18B, further comprising receiving, from one or more microphones, the audio data.

Clause 21B. A device configured to obtain a bitstream representative of audio data describing a soundfield, the device comprising: means for recursively specifying, in the bitstream, audio metadata associated with the audio data, the audio metadata enabling, at least in part, processing of the audio data to obtain one or more speaker feeds; means for specifying, in the bitstream, a representation of the audio data; and means for outputting the bitstream.

Clause 22B. The device of clause 21B, wherein the representation of the audio data includes object-based audio data, and wherein the recursively defined audio metadata includes object metadata descriptive of the object-based audio data.

Clause 23B. The device of any combination of clauses 21B and 22B, wherein the representation of the audio data includes object-based audio data, and wherein the recursively defined audio metadata includes object metadata identifying of a location of the object-based audio data relative to a location of a listener.

Clause 24B. The device of any combination of clauses 21B-23B, wherein the representation of the audio data includes object-based audio data, and wherein the recursively defined audio metadata includes object metadata identifying a location of the object-based audio data relative to a location of a listener as one or more polar coordinates.

Clause 25B. The device of any combination of clauses 24B, further comprising means for specifying, in the bitstream, a conversion indication indicating that the one or more polar coordinates are to be converted into one or more cartesian coordinates.

Clause 26B. The device of any combination of clauses 21B-23B, wherein the recursively defined audio metadata includes object metadata identifying a location of object-based audio data relative to a location of a listener as one or more cartesian coordinates.

Clause 27B. The device of any combination of clauses 21B-26B, wherein the means for recursively specifying the audio metadata comprises: means for specifying, in the bitstream, a first portion of the recursively defined audio metadata, the first portion of the recursively defined audio metadata including a nested indication indicating whether the bitstream includes a second portion of the recursively defined audio metadata; and means for specifying, in the bitstream and when the nested indication indicates that bitstream includes the second portion of the recursively defined audio metadata, the second portion of the recursively defined audio metadata.

Clause 28B. The device of any combination of clauses 21B-26B, wherein the means for recursively specifying the audio metadata comprises means for recursively calling, when a nested indication indicates that the bitstream includes an additional portion of the recursively defined audio metadata, a function to specify, in the bitstream, the additional portion of the recursively defined audio metadata, each of the additional portion of the recursively defined audio metadata including an instance of the nested indication.

Clause 29B. The device of clause 28B, wherein the recursively defined audio metadata identifies a location of the audio data relative to a listener, and wherein each of the additional portions of the recursively defined audio metadata adjusts the location of the audio data relative to a previous location identified by a previous additional portion of the recursively defined audio metadata.

Clause 30B. The device of any combination of clauses 21B-28B, further comprising means for receiving the audio data.

Clause 31B. A non-transitory computer-readable storage medium having stored thereon instructions that, when executed, cause one or more processors to: specify, in a bitstream representative of a compressed version of audio data describing a soundfield, audio metadata associated with the audio data, the audio metadata enabling, at least in part, processing of the audio data to obtain one or more speaker feeds; specify, in the bitstream, a representation of the audio data; and output the bitstream.

Other examples of context in which the techniques may be performed include an audio ecosystem that may include acquisition elements, and playback elements. The acquisition elements may include wired and/or wireless acquisition devices (e.g., Eigen microphones), on-device surround sound capture, and mobile devices (e.g., smartphones and tablets). In some examples, wired and/or wireless acquisition devices may be coupled to mobile device via wired and/or wireless communication channel(s).

In accordance with one or more techniques of this disclosure, the mobile device may be used to acquire a soundfield. For instance, the mobile device may acquire a soundfield via the wired and/or wireless acquisition devices and/or the on-device surround sound capture (e.g., a plurality of microphones integrated into the mobile device). The mobile device may then code the acquired soundfield into the ambisonic coefficients for playback by one or more of the playback elements. For instance, a user of the mobile device may record (acquire a soundfield of) a live event (e.g., a meeting, a conference, a play, a concert, etc.), and code the recording into ambisonic coefficients.

The mobile device may also utilize one or more of the playback elements to playback the ambisonic coded soundfield. For instance, the mobile device may decode the ambisonic coded soundfield and output a signal to one or more of the playback elements that causes the one or more of the playback elements to recreate the soundfield. As one example, the mobile device may utilize the wireless and/or wireless communication channels to output the signal to one or more speakers (e.g., speaker arrays, sound bars, etc.). As another example, the mobile device may utilize docking solutions to output the signal to one or more docking stations and/or one or more docked speakers (e.g., sound systems in smart cars and/or homes). As another example, the mobile device may utilize headphone rendering to output the signal to a set of headphones, e.g., to create realistic binaural sound.

In some examples, a particular mobile device may both acquire a 3D soundfield and playback the same 3D soundfield at a later time. In some examples, the mobile device may acquire a 3D soundfield, encode the 3D soundfield into ambisonic coefficients, and transmit the encoded 3D soundfield to one or more other devices (e.g., other mobile devices and/or other non-mobile devices) for playback.

Yet another context in which the techniques may be performed includes an audio ecosystem that may include audio content, game studios, coded audio content, rendering engines, and delivery systems. In some examples, the game studios may include one or more DAWs which may support editing of ambisonic signals. For instance, the one or more DAWs may include ambisonic plugins and/or tools which may be configured to operate with (e.g., work with) one or more game audio systems. In some examples, the game studios may output new stem formats that support ambisonics. In any case, the game studios may output coded audio content to the rendering engines which may render a soundfield for playback by the delivery systems.

The techniques may also be performed with respect to exemplary audio acquisition devices. For example, the techniques may be performed with respect to an Eigen microphone which may include a plurality of microphones that are collectively configured to record a 3D soundfield. In some examples, the plurality of microphones of Eigen microphone may be located on the surface of a substantially spherical ball with a radius of approximately 4 cm. In some examples, the audio encoding device 20 may be integrated into the Eigen microphone so as to output a bitstream 21 directly from the microphone.

Another exemplary audio acquisition context may include a production truck which may be configured to receive a signal from one or more microphones, such as one or more Eigen microphones. The production truck may also include an audio encoder, such as spatial audio encoding device 20 of FIG. 3.

The mobile device may also, in some instances, include a plurality of microphones that are collectively configured to record a 3D soundfield. In other words, the plurality of microphone may have X, Y, Z diversity. In some examples, the mobile device may include a microphone which may be rotated to provide X, Y, Z diversity with respect to one or more other microphones of the mobile device. The mobile device may also include an audio encoder, such as spatial audio encoding device 20 of FIG. 3.

A ruggedized video capture device may further be configured to record a 3D soundfield. In some examples, the ruggedized video capture device may be attached to a helmet of a user engaged in an activity. For instance, the ruggedized video capture device may be attached to a helmet of a user whitewater rafting. In this way, the ruggedized video capture device may capture a 3D soundfield that represents the action all around the user (e.g., water crashing behind the user, another rafter speaking in front of the user, etc. . . . ).

The techniques may also be performed with respect to an accessory enhanced mobile device, which may be configured to record a 3D soundfield. In some examples, the mobile device may be similar to the mobile devices discussed above, with the addition of one or more accessories. For instance, an Eigen microphone may be attached to the above noted mobile device to form an accessory enhanced mobile device. In this way, the accessory enhanced mobile device may capture a higher quality version of the 3D soundfield than just using sound capture components integral to the accessory enhanced mobile device.

Example audio playback devices that may perform various aspects of the techniques described in this disclosure are further discussed below. In accordance with one or more techniques of this disclosure, speakers and/or sound bars may be arranged in any arbitrary configuration while still playing back a 3D soundfield. Moreover, in some examples, headphone playback devices may be coupled to a decoder 24 via either a wired or a wireless connection. In accordance with one or more techniques of this disclosure, a single generic representation of a soundfield may be utilized to render the soundfield on any combination of the speakers, the sound bars, and the headphone playback devices.

A number of different example audio playback environments may also be suitable for performing various aspects of the techniques described in this disclosure. For instance, a 5.1 speaker playback environment, a 2.0 (e.g., stereo) speaker playback environment, a 9.1 speaker playback environment with full height front speakers, a 22.2 speaker playback environment, a 16.0 speaker playback environment, an automotive speaker playback environment, and a mobile device with ear bud playback environment may be suitable environments for performing various aspects of the techniques described in this disclosure.

In accordance with one or more techniques of this disclosure, a single generic representation of a soundfield may be utilized to render the soundfield on any of the foregoing playback environments. Additionally, the techniques of this disclosure enable a rendered to render a soundfield from a generic representation for playback on the playback environments other than that described above. For instance, if design considerations prohibit proper placement of speakers according to a 7.1 speaker playback environment (e.g., if it is not possible to place a right surround speaker), the techniques of this disclosure enable a render to compensate with the other 6 speakers such that playback may be achieved on a 6.1 speaker playback environment.

Moreover, a user may watch a sports game while wearing headphones. In accordance with one or more techniques of this disclosure, the 3D soundfield of the sports game may be acquired (e.g., one or more Eigen microphones may be placed in and/or around the baseball stadium), ambisonic coefficients corresponding to the 3D soundfield may be obtained and transmitted to a decoder, the decoder may reconstruct the 3D soundfield based on the ambisonic coefficients and output the reconstructed 3D soundfield to a renderer, the renderer may obtain an indication as to the type of playback environment (e.g., headphones), and render the reconstructed 3D soundfield into signals that cause the headphones to output a representation of the 3D soundfield of the sports game.

In each of the various instances described above, it should be understood that the spatial audio encoding device 20 may perform a method or otherwise comprise means to perform each step of the method for which the spatial audio encoding device 20 is configured to perform In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the audio encoding device 20 has been configured to perform.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, as used herein, “A and/or B” means “A or B”, or both “A and B.”

Various aspects of the techniques have been described. These and other aspects of the techniques are within the scope of the following claims.

1. A device configured to process a bitstream representative of audio data that describes a soundfield, the device comprising:
one or more memories configured to store at least a portion of the bitstream;
one or more processors configured to:
obtain, from the bitstream, recursively defined audio metadata;
obtain, from the bitstream, a representation of the audio data;
process, based on the recursively defined audio metadata, the representation of the audio data to obtain one or more speaker feeds; and
output the one or more speaker feeds to one or more speakers.

2. The device of claim 1,
wherein the representation of the audio data includes object-based audio data, and
wherein the recursively defined audio metadata includes object metadata descriptive of the object-based audio data.

3. The device of claim 1,
wherein the representation of the audio data includes object-based audio data, and
wherein the recursively defined audio metadata includes object metadata identifying of a location of the object-based audio data relative to a location of a listener.

4. The device of claim 1,
wherein the representation of the audio data includes object-based audio data, and
wherein the recursively defined audio metadata includes object metadata identifying a location of the object-based audio data relative to a location of a listener as one or more polar coordinates.

5. The device of claim 4,
wherein the one or more processors are further configured to:
obtain, from the bitstream, a conversion indication indicating that the one or more polar coordinates are to be converted into one or more cartesian coordinates; and
convert, responsive to the conversion indication, the one or more polar coordinates to the one or more cartesian coordinates, and
wherein the one or more processors are configured to process, based on the one or more cartesian coordinates, the representation of the audio data to obtain the audio data.

6. The device of claim 1, wherein the recursively defined audio metadata includes object metadata identifying a location of object-based audio data relative to a location of a listener as one or more cartesian coordinates.

7. The device of claim 1, wherein the one or more processors are configured to:
obtain, from the bitstream, a first portion of the recursively defined audio metadata, the first portion of the recursively defined audio metadata including a nested indication indicating whether the bitstream includes a second portion of the recursively defined audio metadata; and
obtain, from the bitstream and responsive to the nested indication indicating that bitstream includes the second portion of the recursively defined audio metadata, the second portion of the recursively defined audio metadata.

8. The device of claim 1, wherein the one or more processors are configured to recursively call, based on a nested indication indicating whether the bitstream includes an additional portion of the recursively defined audio metadata, a function to obtain, from the bitstream, the additional portion of the recursively defined audio metadata, each of the additional portions of the recursively defined audio metadata including an instance of the nested indication.

9. The device of claim 8,
wherein the recursively defined audio metadata identifies a location of the audio data relative to a listener, and
wherein each of the additional portions of the recursively defined audio metadata adjusts the location of the audio data relative to a previous location identified by a previous additional portion of the recursively defined audio metadata.

10. The device of claim 1,
wherein the representation of the audio data comprises object-based audio data, and
wherein the one or more processors are configured to render, based on the recursively defined audio metadata, the object-based audio data to obtain the one or more speaker feeds.

11. A method of processing a bitstream representative of audio data that describes a soundfield, the method comprising:
obtaining, from the bitstream, recursively defined audio metadata;
obtaining, from the bitstream, a representation of the audio data;
processing, based on the recursively defined audio metadata, the representation of the audio data to obtain one or more speaker feeds; and
outputting the one or more speaker feeds to one or more speakers.

12. The method of claim 11,
wherein the representation of the audio data includes object-based audio data, and
wherein the recursively defined audio metadata includes object metadata descriptive of the object-based audio data.

13. The method of claim 11,
wherein the representation of the audio data includes object-based audio data, and
wherein the recursively defined audio metadata includes object metadata identifying of a location of the object-based audio data relative to a location of a listener.

14. The method of claim 11,
wherein the representation of the audio data includes object-based audio data, and
wherein the recursively defined audio metadata includes object metadata identifying a location of the object-based audio data relative to a location of a listener as one or more polar coordinates.

15. The method of claim 14, further comprising:
obtaining, from the bitstream, a conversion indication indicating that the one or more polar coordinates are to be converted into one or more cartesian coordinates; and
converting, responsive to the conversion indication, the one or more polar coordinates to the one or more cartesian coordinates, and
wherein processing the representation of the audio data comprises processing, based on the one or more cartesian coordinates, the representation of the audio data to obtain the audio data.

16. The method of claim 11, wherein the recursively defined audio metadata includes object metadata identifying a location of object-based audio data relative to a location of a listener as one or more cartesian coordinates.

17. The method of claim 11, wherein obtaining the recursively defined audio metadata comprises:
obtaining, from the bitstream, a first portion of the recursively defined audio metadata, the first portion of the recursively defined audio metadata including a nested indication indicating whether the bitstream includes a second portion of the recursively defined audio metadata; and
obtaining, from the bitstream and responsive to the nested indication indicating that bitstream includes the second portion of the recursively defined audio metadata, the second portion of the recursively defined audio metadata.

18. The method of claim 11, wherein obtaining the recursively defined audio metadata includes recursively calling, based on a nested indication indicating whether the bitstream includes an additional portion of the recursively defined audio metadata, a function to obtain, from the bitstream, the additional portion of the recursively defined audio metadata, each of the additional portions of the recursively defined audio metadata including an instance of the nested indication.

19. The method of claim 18,
wherein the recursively defined audio metadata identifies a location of the audio data relative to a listener, and
wherein each of the additional portions of the recursively defined audio metadata adjusts the location of the audio data relative to a previous location identified by a previous additional portion of the recursively defined audio metadata.

20. The method of claim 11,
wherein the representation of the audio data comprises object-based audio data, and
wherein processing the representation of the audio data comprises rendering, based on the recursively defined audio metadata, the object-based audio data to obtain the one or more speaker feeds.

21. A device configured to obtain a bitstream representative of audio data describing a soundfield, the device comprising:
one or more memories configured to store the audio data;
one or more processors configured to:
recursively specify, in the bitstream, audio metadata associated with the audio data, the audio metadata enabling, at least in part, processing of the audio data to obtain one or more speaker feeds;
specify, in the bitstream, a representation of the audio data; and
output the bitstream.

22. The device of claim 21,
wherein the representation of the audio data includes object-based audio data, and
wherein the recursively defined audio metadata includes object metadata descriptive of the object-based audio data.

23. The device of claim 21,
wherein the representation of the audio data includes object-based audio data, and
wherein the recursively defined audio metadata includes object metadata identifying of a location of the object-based audio data relative to a location of a listener.

24. The device of claim 21,
wherein the representation of the audio data includes object-based audio data, and
wherein the recursively defined audio metadata includes object metadata identifying a location of the object-based audio data relative to a location of a listener as one or more polar coordinates.

25. The device of claim 24, wherein the one or more processors are further configured to specify, in the bitstream, a conversion indication indicating that the one or more polar coordinates are to be converted into one or more cartesian coordinates.

26. The device of claim 21, wherein the recursively defined audio metadata includes object metadata identifying a location of object-based audio data relative to a location of a listener as one or more cartesian coordinates.

27. The device of claim 21, wherein the one or more processors are configured to:
specify, in the bitstream, a first portion of the recursively defined audio metadata, the first portion of the recursively defined audio metadata including a nested indication indicating whether the bitstream includes a second portion of the recursively defined audio metadata; and
specify, in the bitstream and when the nested indication indicates that bitstream includes the second portion of the recursively defined audio metadata, the second portion of the recursively defined audio metadata.

28. The device of claim 21, wherein the one or more processors are configured to recursively call, when a nested indication indicates that the bitstream includes an additional portion of the recursively defined audio metadata, a function to specify, in the bitstream, the additional portion of the recursively defined audio metadata, each of the additional portion of the recursively defined audio metadata including an instance of the nested indication.

29. A method of obtaining a bitstream representative of audio data describing a soundfield, the device comprising:
recursively specifying, in the bitstream, audio metadata associated with the audio data, the audio metadata enabling, at least in part, processing of the audio data to obtain one or more speaker feeds;
specifying, in the bitstream, a representation of the audio data; and
outputting the bitstream.
